(19) United States
(12) Patent Application Publication
(10) Pub. No.: US 2015/0115024 A1
(43) Pub. Date: Apr. 30, 2015

(54) Containers, Systems and Methods for Packing, Shipping and Storing Produce

(71) Applicant: Chiquita Brands LLC, Charlotte, NC (US)

(72) Inventors: Claudio FINOL, Nyon (CH); Francisco RODRIGUEZ, Alajuela (CR); Arnoldo LAGOS, Jimenez (CR)

(21) Appl. No.: 14/526,803

(22) Filed: Oct. 29, 2014

Related U.S. Application Data
(60) Provisional application No. 61/898,034, filed on Oct. 31, 2013.

(51) Int. Cl. B65D 5/468; B65B 5/10; B65G 57/02; B65D 5/42

(52) U.S. Cl. CPC B65D 5/4608; B65D 5/4295; B65B 5/10; B65G 57/02
USPC 229/117.16; 229/120; 220/23.83; 53/473; 414/802

(57) ABSTRACT

Improved produce containers, systems and method for packing and shipping the same, utilize containers that are smaller and have a lower Box Declared Weight than industry-standard banana boxes. The improved system comprises improved containers and an industry-standard sized banana pallet, which allows for a relatively higher weight of bananas to be shipped, while providing effective means to vary ventilation and temperature of the bananas, particularly those that are near the center of the pallet load. The method allows for reduced handling, and as a result, reduced bruising and scarring of bananas, while improving working conditions for those handling the containers.

This application is related to, and claims priority from, U.S. Provisional Patent Application No. 61/898,034, filed Oct. 31, 2013, which is incorporated herein by reference.

### TECHNICAL FIELD

The present disclosure relates to the field of packaging, shipping and storing produce. More particularly, the present disclosure is directed to improved containers, which optimize shipping and storage conditions for produce, while minimizing the strain on individuals who handle the containers. Moreover, the present disclosure is directed to improved systems and methods, which maximize the number of produce containers that may be shipped on industry standard-sized banana pallets, and by extension, maximize the amount of produce that may be shipped on those same banana pallets, without negatively impacting produce quality or shipping and handling costs.

### BACKGROUND

Most produce must be transported from one point to another prior to sale to a consumer, and as such, it is typically stored for a period of time at a number of locations. Often during transport and storage, ventilation, heating, and/or cooling must be applied to the products for various reasons. For example, perishable produce such as fruits and vegetables may require ventilation and cooling in order to maintain their freshness. Without such ventilation or temperature control means, these products might arrive at their final destination in a spoiled or damaged condition. Therefore, it may not be sufficient to merely package the perishable produce in closed containers.

Previous containerization methods for perishable produce have employed containers having various ventilation means. For example, it is common for produce to be shipped to retailers from the location where it is grown in corrugated boxes having a plurality of ventilation openings. Such corrugated boxes not only provide a means for ventilating and controlling the temperature of the produce, but can also be light-weight and relatively inexpensive to manufacture.

At certain points during shipping and/or storage periods of produce, it may be necessary to increase ventilation, or to raise or lower the temperature of the produce, in order to ensure optimal freshness. One product for which this is particularly true is bananas. Bananas are typically packed in the form of banana clusters (or hands) into corrugated containers (i.e., boxes) at the plantation where they are harvested in a very green, un-ripened state. The cardboard boxes are then placed on banana pallets within large shipping containers, which are in turn placed in refrigerated ships, e.g., reefer ships. During shipment, the pulp temperature of the bananas is typically kept at a temperature between about 13° C. and 15° C. Once the ship has docked, the bananas may be transferred to refrigerated trucks or rail cars, and transported to a warehouse or the like. Once again, the pulp temperature may be maintained between about 13° C. and 15° C. in order to retard the ripening of the bananas, thereby increasing their shelf life. In order to maintain the appropriate temperature range, it is necessary to provide ventilation means within the cardboard or corrugated boxes. This is typically achieved by providing a plurality of ventilation openings about the surfaces of the boxes. In this fashion, cooled air can be circulated within the boxes, thereby maintaining the proper pulp temperature.

Once the bananas have reached the warehouse, the boxes are placed in ripening rooms where the pulp temperature may be permitted to rise to about 16° C. to 17° C. Ethylene gas is also circulated about and within the containers by means of the ventilation openings. The combination of increased temperature and ethylene gas will hasten the ripening process, thereby reducing the time necessary for the bananas to fully ripen. However, once this process has been completed, it is desirable to remove ethylene gas and decrease the temperature of the bananas in order to decelerate ripening. Since the ripening process within the bananas themselves releases ethylene gas, and since the ripening process may continue even at temperatures below about 16° C., it is critical that sufficient ventilation be provided in order to reduce the pulp temperature and remove ethylene. Thus, once the bananas are removed from the ripening rooms and transported to the retailer, it is usually necessary to take steps to ensure that increased ventilation can be provided to the bananas. If the ethylene gas is not removed from the bananas, or the temperature is not sufficiently decreased, the bananas will continue to ripen at an accelerated rate, thereby shortening their shelf life. Thus, the containers employed for produce such as bananas must be able to facilitate the varying ventilation and temperature control needs during transport and storage.

During the aforementioned life cycle of produce from the field or plantation to the retailer, there are a number of times during which various individuals must handle a container of produce. For example, a picker may fill the container in the field in which the produce is grown and hoist it onto a truck, after which, the container is then lifted off of the truck and stacked onto a pallet. Once at a store, the container is unloaded from a truck and placed into storage. When the produce is to be sold, the container is removed from storage and the produce placed on display. In sum, there are a number of times during the life cycle of produce when an individual must lift and/or carry produce containers, which may be large and heavy. For example, an industry-standard banana box is 52 cm long, by 38 cm wide, and 25 cm high, and may hold up to about 18.1 kg of fruit.

Based upon the foregoing, the use of a smaller container would seem desirable in order to improve handling conditions. However, this has not been the case as evidenced by the industry's failure to do so due to disadvantages of using a smaller container, particularly in the context of packing, shipping and storing bananas. For example, reduction in the size of the standard banana box would mean that fewer bananas are present in each box, which in turn would mean that to ship the same amount of bananas on an industry standard-sized banana pallet, more boxes would have to be loaded onto it. Having more boxes on an industry standard-sized banana pallet can be problematic, because it can make it even more difficult to account for the varying ventilation and temperature control needs of the produce contained in the boxes, particularly those that are near the center of the pallet load.

Based upon the forgoing, it is clear that a need remains for an improved produce container, as well as an improved method for packing, shipping and storing the same. Such improvements should allow for maintenance of favorable shipping and storage conditions, while providing for improved handling conditions. The need is particularly felt for bananas, but also applies to other produce, including other fruits and vegetables, which require similar handling, and may also have varying requirements during the packing, shipping and storing processes.

### SUMMARY

The present disclosure addresses the long-felt need in the produce industry, particularly the banana industry, for improved containers, which may optimize packing, shipping and storage conditions for bananas, while minimizing the strain on individuals who handle the containers. Moreover, the present disclosure is directed to improved systems and methods, which maximize the number of containers that may be shipped on industry standard-sized pallets, particularly banana pallets, and by extension, maximize the amount of produce that may be shipped on those same pallets, without negatively impacting the quality of the produce, and the shipping and handling costs. While the disclosure focuses primarily on bananas, it should be understood that the disclosed improvements may apply to other produce, such as respiring fruits including, but not limited to: avocados, bananas, mangoes, plantains, papayas, tomatoes, berries, stone fruit, mushrooms, bean sprouts, and broccoli.

In some aspects, the disclosure is directed to improved containers for packing, shipping and/or storing produce, particularly bananas. The improved containers, e.g. banana boxes, comprise: a pair of opposed vertical side panels comprising a first side panel and a second side panel; a pair of opposed vertical end panels comprising a first end panel and a second end panel; a top panel; and a bottom panel opposed to the top panel. The improved containers also comprise a plurality of ventilation apertures disposed along a top perimeter of the container and a plurality of ventilation apertures disposed along a bottom perimeter of the container. In use, the improved containers have outer dimensions of 40 cm long, by 35 cm wide, by 25 cm high, within a manufacturing tolerance of ±5 mm. Thus, the improved containers are substantially smaller than the industry-standard banana box, which is 52 cm long, by 38 cm wide, by 25 cm high. When packed with bananas, the improved containers weigh substantially less than the industry-standard banana box. To wit, whereas the industry-standard banana box has a Maximum Declared Weight of 18.14 kg per box, the improved containers have a Maximum Declared Weight of from 12.7 kg to 13.0 kg, or more particularly, 13.0 kg.

In some aspects, the disclosure is directed to an improved system for packing, shipping and/or storage of produce, particularly bananas. The improved system comprises a plurality of improved containers as described above, and an industry-standard-sized banana pallet having dimensions of about 120 cm long by about 106 cm wide. In some aspects, a first layer comprising nine containers is placed on the pallet, and a second layer of nine containers is stacked on top of the first layer of containers, and so on, until eight layers of containers are stacked on the pallet. In some aspects, the containers are stacked on the pallet until nine layers of nine containers each are stacked on the pallet. In any case, the layers of containers are configured such that at least a portion of the ventilation apertures of each container is aligned with at least a portion of the ventilation apertures of one or more adjacent containers. By aligning the ventilation apertures in this way, at least one continuous vertical gas flow path, and at least one continuous horizontal gas flow path, extends through all of the layers of the stacked containers. The gas flow paths readily allow gases, such as air or ethylene, to freely flow between and among the stacked containers and layers thereof. The resulting ventilation may facilitate varying ventilation and/or temperature control needs of the produce during transport and/or storage.

The improved system allows for substantially more produce to be shipped as compared to current banana pallet systems. Current systems utilizing industry-standard banana boxes and banana pallets typically have a Maximum Declared Weight of about 870 kg per pallet. In contrast, the improved systems of the present disclosure may have a Maximum Declared Weight of from about 914 kg to about 1,053 kg.

In some aspects, the disclosure is directed to a method of increasing the amount of bananas that may be shipped on an industry standard-sized banana pallet having dimensions of about 120 cm long, by about 106 cm wide. The method may comprise the following steps. A plurality of improved banana containers as described above is provided. Each banana box is packed with bananas. The banana boxes are stacked on the industry-standard pallet in layers. In some aspects, the banana boxes are stacked in eight layers of nine boxes each, and in some aspects, the banana boxes are stacked in nine layers of nine boxes each. The boxes are positioned in the various layers such that a portion of each box's ventilation apertures is aligned with a portion of the ventilation apertures of at least one adjacent box. By aligning the ventilation apertures in this way, at least one continuous vertical gas flow path, and at least one continuous horizontal gas flow path is formed throughout the layers of boxes. As noted above, the gas flow paths readily allow gases, such as air or ethylene, to freely flow between and among the stacked containers and layers thereof. The resulting ventilation may facilitate varying ventilation and/or temperature control needs of the produce during transport and/or storage.

### BRIEF DESCRIPTION OF THE DRAWINGS

While the specification concludes with claims particularly pointing out and distinctly claiming aspects of the present invention, it is believed the same will be better understood from the following description taken in conjunction with the accompanying drawings in which:

FIG. 1 is a perspective view of an improved container per the present disclosure;

FIG. 2 is a plan view of an unassembled top portion of an improved container per the present disclosure;

FIG. 3 is a plan view of an unassembled bottom portion of an improved container per the present disclosure;

FIG. 4 is a plan view of a bottom of an improved container per the present disclosure;

FIG. 5 is a plan view of a tunnel pad of use in the improved container of the present disclosure;

FIG. 6 is a perspective view of an improved system per the present disclosure;

FIG. 7 is a perspective view of an improved system per the present disclosure; and

FIG. 8 is a perspective view showing two layers of a palletized load of improved containers of the present disclosure showing the alignment of adjacent ventilation apertures of adjacent containers.

### DETAILED DESCRIPTION

The term “container” is used interchangeably herein with “box” and “carton.”

As used herein, the term “Maximum Declared Weight” (hereinafter, “MDW”) means the maximum weight of only the produce itself (i.e., not including the packaging weight) that may be present in a container or on a pallet.

As used herein, the term “industry standard-sized pallet” (hereinafter, “ISP”) means a pallet, more particularly an industry standard-sized banana pallet, having dimensions of about 120 cm long (L), by about 106 cm wide (W), by about 14.5 cm high (H).

As used herein, the term “gas” encompasses any gas that may be applied to produce, including but not limited to ethylene gas and mixed gases, such as air.

Reference will now be made in detail to the aspects of the disclosure, examples of which are illustrated in the accompanying drawings, wherein like numerals indicate the same elements throughout the views.

### Improved Containers:

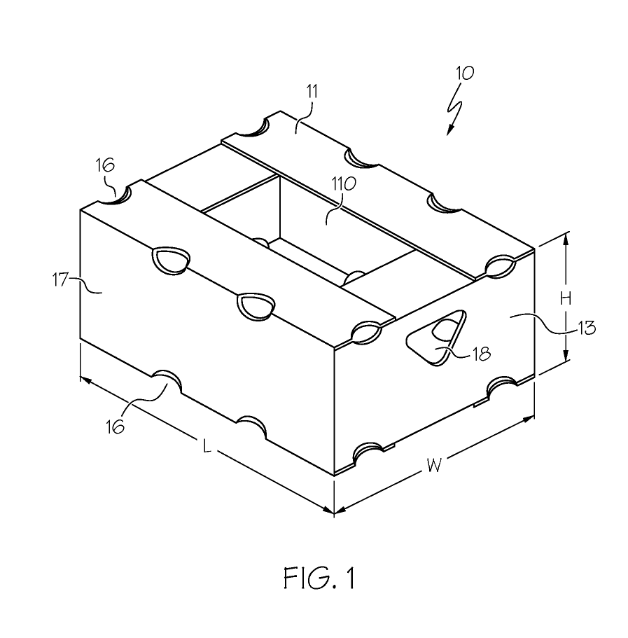

Referencing FIGS. 1-3, improved containers for produce, particularly bananas, are provided. Whereas, the industry-standard banana container has the dimensions of 52 cm long, by 38 cm wide, by 25 cm high, the improved containers are substantially smaller. As can be seen in FIG. 1-3, the improved containers are 40 cm long (L), by 35 cm wide (W), by 25 cm high (H), within a manufacturing tolerance of ±5 mm, ±3 mm or ±1 mm. It is important that the defined dimensions for the improved containers be adhered to strictly within the manufacturing tolerances defined above; otherwise, the containers may not fit snugly on an ISP, or may overhang the edges of an ISP, thereby increasing the chances for damage during shipping to the produce contained therein.

As a result of their new, relatively compact design, the improved containers provide a number of advantages over those that are currently used within the industry. A first advantage is that the improved containers are easier to handle, because, as noted above, they are substantially smaller, and when packed with produce, weighs less than the industry-standard banana box. For example, in some aspects, the improved containers may have an MDW of from about 12.7 kg to about 13.0 kg, or any given weight there between. In some aspects, the improved containers may have an MDW of about: 12.7 kg; 12.8 kg; 12.9 kg; or 13.0 kg. Thus, the improved containers are significantly lighter than the industry-standard banana box, which has an MDW of about 18.1 kg. The reduced size and weight of the improved containers is particularly advantageous for individuals who harvest produce, cargo handlers, store personnel and consumers. Indeed, the European Agency for Health and Safety at Work has recognized that manual handling of lighter and smaller loads drives down injury rates, and the resulting costs to individuals, their employers and the national economy. See: Lighten the Load: Information for Employers and Workers of the Retail Trade Sector, National Labour Inspectorate (Warsaw 2008).

A second advantage is that, because of their relatively small size, the improved containers allow for more containers and by extension, more fruit, to be stacked, shipped and/or stored on an ISP, without damaging the fruit. This aspect of the improved containers is described in further detail below.

The improved containers are generally made from corrugated cardboard, but can be made from any material typically used for making shipping boxes. The choice of material may be governed by such factors including, but not limited to, cost, strength, durability and combinations thereof.

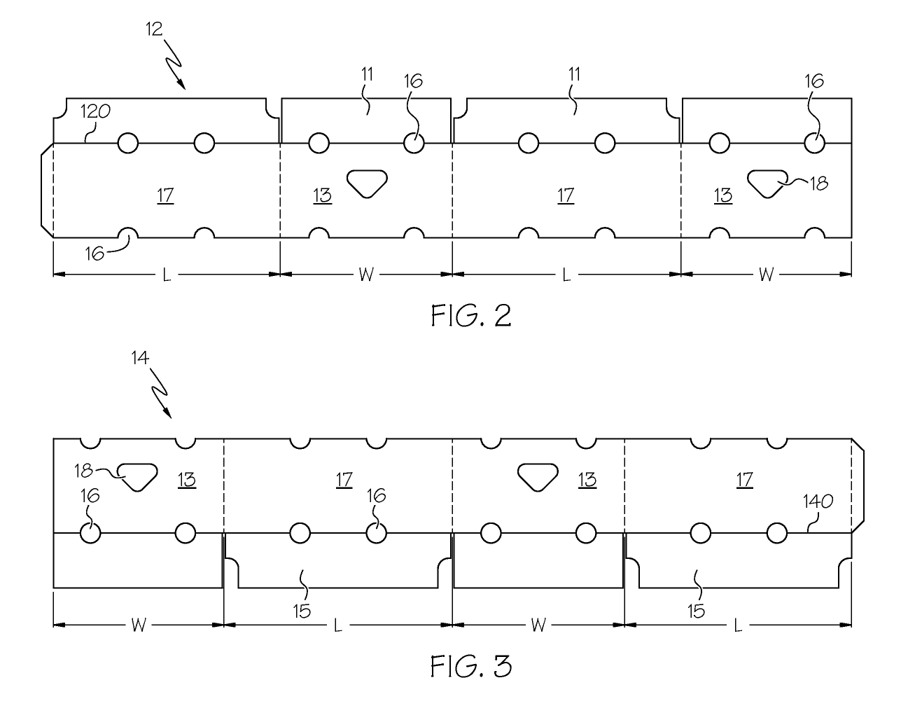

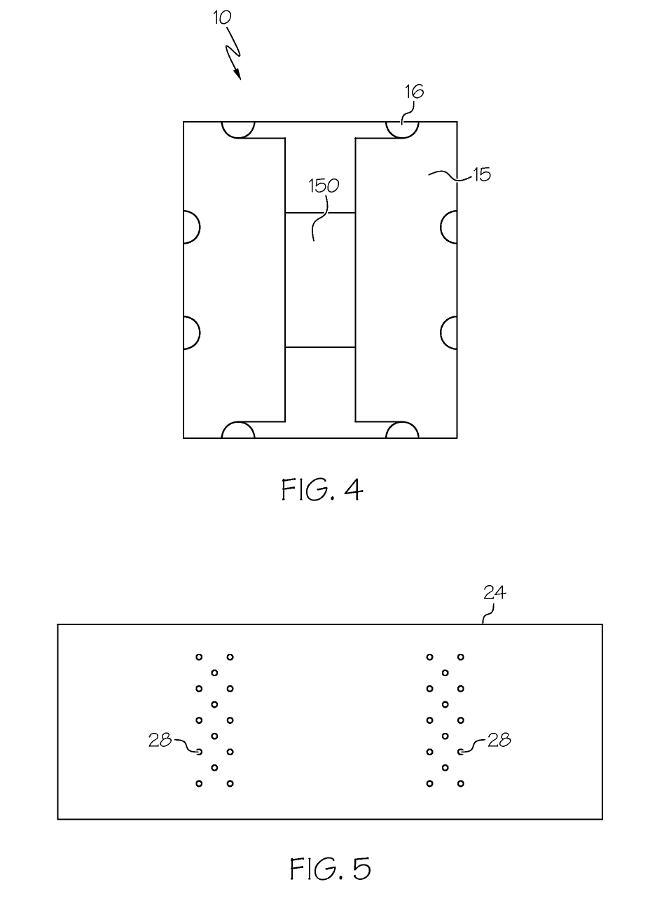

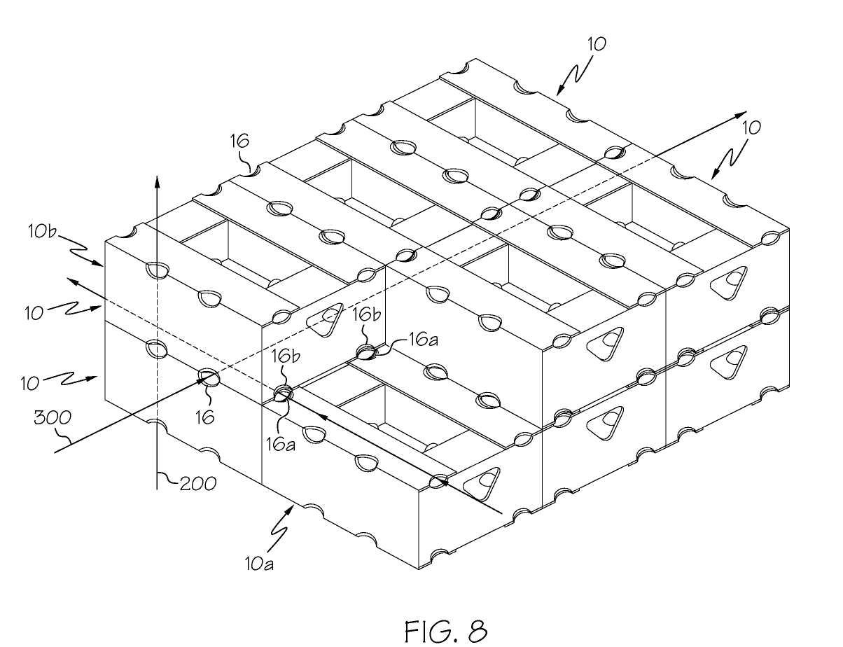

Referring to FIGS. 2 and 3, an improved container may generally comprise a top portion 12 (FIG. 2), and a base portion 14 (FIG. 3), and may be referred to as a full-telescoping, half-slotted container (hereinafter, “HSC”). When assembled, and as shown in FIG. 1, the improved container 10 includes a top panel 11, a pair of opposed end panels 13 (FIG. 2), a pair of opposed side panels 17 (FIG. 2), and a bottom panel 15 (FIG. 4) opposed to the top panel. Each of the top panel 11 and bottom panel 15 may include an open center, respectively 110 (FIG. 1) and 150 (FIG. 7).

In some aspects, the top portion 12 and base portion 14 are preferably of approximately equal depth as shown in FIGS. 2 and 3. To assemble the container 10, the top portion 12 telescopically slides over the base portion 14. As depicted particularly in FIG. 1, the ventilation apertures 16 in the base portion 14 and top portion 12 are aligned when assembled into a container 10. The top panel 11 and bottom panel 15 may each have flaps which are folded over and glued to one another in order to close each panel. When closed, each of the top and bottom panels may comprise an open center (110, 150), as shown respectively in FIG. 1 and FIG. 4. Handholds 18 may be provided for additional ventilation, and/or for ease of transporting the container 10.

It is important that the containers be structured so that air can circulate through all of the containers when they are stacked on a pallet. This is particularly important in aspects according to the present disclosure, since they may allow a relatively larger number of containers to be stacked on each pallet, i.e., up to nine layers of nine containers, as opposed to conventional systems utilizing standard containers, which typically allow for only eight layers of eight containers. Stacking more containers on a pallet makes it more difficult to circulate gas through and among the containers, and to regulate temperature of the containers, particularly those that are toward the center of the pallet.

Based upon the foregoing, it is clear that the size and placement of a container's ventilation holes must be carefully considered so as to obtain appropriate air flow without compromising the structural strength of the carton. Ventilation and air flow serve two important functions with regard to banana cartons stacked on a pallet: (1) they allow for an optimal banana temperature (for storage and ripening) to be reached; and (2) they provide for uniformity of that temperature across the pallet (thereby minimizing banana color differentials across the pallet). Ventilation and air flow are usually achieved by placing openings in the container which are not blocked (and allow air flow) when individual cartons are stacked on top of each other and adjacent to one another. Examples of such banana carton ventilation systems, which may be of use in the improved systems of the present disclosure, are described in PCT Published Patent Application WO 2004/045972, published Jun. 3, 2004; and U.S. Published Patent Application 2003/0198714, published Oct. 23, 2003; each of which are incorporated by reference herein.

The improved containers comprise a plurality of ventilation apertures disposed thereon. Referring to FIGS. 2 and 3, the improved containers 10 may comprise eight ventilation apertures 16 disposed substantially equidistantly along its upper perimeter 120, and eight ventilation apertures 16 disposed substantially equidistantly along its bottom perimeter 140. In some aspects, the apertures are round and/or oval, but may be of any suitable shape to effect the desired ventilation. In some aspects, the apertures 16 have a diameter of about 2.5 cm to about 7.6 cm, or any given diameter there between. In some aspects, the apertures 16 have a diameter of: about 2.5 cm; about 3.8 cm; about 5.1 cm; or about 6.4 cm.

FIG. 4 illustrates a top plan view of the bottom panel 15 of the container 10. As can be seen in the figure, approximately one half of each ventilation aperture 16 is disposed on the bottom of the container about the edge 140 of the bottom panel 15. The remaining half of each ventilation aperture is disposed on an adjacent vertical panel 13 or 17 (FIG. 2). The top panel 11 (FIG. 1) includes a similar ventilation aperture configuration. These ventilation apertures configurations advantageously allow for the vertical intercommunication between containers of different layers as discussed in further detail below.

As best shown in FIGS. 1-3, it can be seen that in some aspects of the improved containers, the ventilation apertures may be placed such that their widest points coincide with the horizontal scores that fold when each piece of an improved container is erected. In other words, each ventilation aperture 16 is disposed on the improved container 10 such that it either has: (a) a first part disposed along a peripheral edge 120 of the top panel 11, and a second portion disposed along a peripheral edge 120 of one of the pair of opposed vertical side panels 17 or one of the pair of opposed vertical end panels 13; or (b) a first part disposed along a peripheral edge 140 of the bottom panel 15, and a second portion disposed along a peripheral edge 140 of one of the pair of opposed vertical side panels 17 or one of the pair of opposed vertical end panels 13.

As shown in FIG. 4, an opening 150 in the bottom panel 15 of an improved container serves as a central ventilation region in the bottom portion 14 of the container 10. As shown in FIG. 1, a like opening 110 in the top panel 11 of an improved container, also serves as a central ventilation region in the top portion 12 of the container 10. As a practical matter, most ventilation through these openings, 150 and 110, tends to be blocked in prior art HSC boxes due to the fruit disposed there under.

Unlike the ventilation pattern of prior art containers, ventilation patterns of the improved containers may not include ventilation apertures cut into the middle regions of the pair of vertical side panels 13, and/or pair of vertical end panels 17. The lack of such ventilation apertures provides a number of advantages. For instance, ventilation aperture(s) located in the middle regions of a vertical side and/or end panel of a container tend to be blocked or obstructed by the produce packed therein. Moreover, cutting apertures into the middle regions of a container's vertical panels may reduce its top to bottom compression strength. The improved containers eliminate these disadvantages by placing ventilation apertures along the fold lines of the containers, and in some aspects, by splitting the apertures substantially in two halves onto two adjacent panels.

The ventilation pattern of the improved containers provides a superior ventilation pattern for bananas or other produce. The present design enhances the air circulation through the entire pallet load, and by extension, may allow for relatively faster cooling rates. The optimization of cooling is achieved by locating the ventilation holes in the upper and lower perimeters of the containers in such a way that they are shared by adjacent panels of the container as described previously. This design may further minimize the likelihood of scarred fruit resulting from fruit engaging the ventilation apertures.

Fruit, particularly bananas, may be packed into the improved containers in any suitable fashion, which reduces damage to the fruit, while maintaining gas flow through the container. For example, hands of bananas may be packed in four rows, which in turn comprises two lower and two upper rows. The two lower rows may be covered with a paper tunnel pad to improve pack stability, and to protect the lower rows from damage, abrasion and/or scarring that could be caused by the two upper rows. In the past, the two lower rows of bananas enclosed by the tunnel pad have been harder to ventilate adequately as compared with the top two rows of fruit in a container. As such, undesirable temperature differences have resulted within prior art containers during transportation and ripening.

As shown in FIG. 5, the container of this invention includes a special paper tunnel pad 24 with improved ventilation characteristics compared to those achieved using prior art tunnel pads. Ventilation holes 28 are arranged in groups and are placed to coincide with the apertures 16 in the lower perimeter of the containers in such a way that air circulation is maximized. Examples of other tunnel pads which may be of use in the improved containers are described in PCT Published Patent Application WO 2004/045972, which is incorporated herein by reference.

When perishable produce, such as bananas, is shipped in an HSC, a plastic inner wrap or bag is typically employed to protect the fruit. This inner wrap is typically a tube made of plastic with a plurality of ventilation slits provided about the surface of the bag. The bag is typically placed in the base portion of a container, and the open edges of the bag are draped its sidewalls. In this fashion fruit, such as bananas, may be layered therein. The limited ventilation of the prior art containers forced the producers to use a plastic bag with a very high number of ventilation openings to enable the cooling and ripening process to proceed adequately and to produce a final product with a fairly uniform color and temperature. Such bags tended to achieve desired ventilation by caused undesirable fruit dehydration and freshness loss. Examples of inner wraps having relatively fewer ventilation openings, and which may be of use in the improved containers, are described in PCT Published Patent Application WO 2004/045972.

Testing of improved containers of the present disclosure has not only demonstrated advantageously decreased cooling times, but also increased uniformity in fruit temperature through the entire pallet load of stacked containers thereby achieving substantial homogenization of the unripe or green life of all fruit or bananas contained therein. The improved containers have also been proven to improve fruit temperature management during the ripening process when the fruit ripening is triggered by gassing the fruit with ethylene. As a result, bananas are delivered to retail with a narrower, more uniform range of color distribution and with fruit of similar ripeness and a longer useful life.

### Improved Systems:

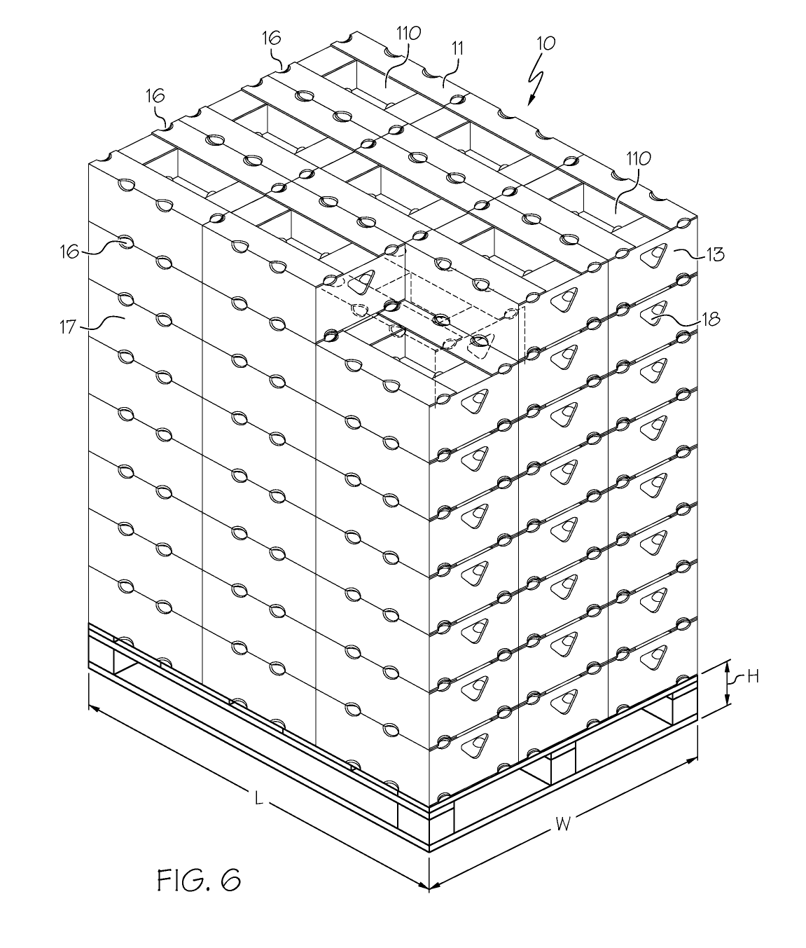

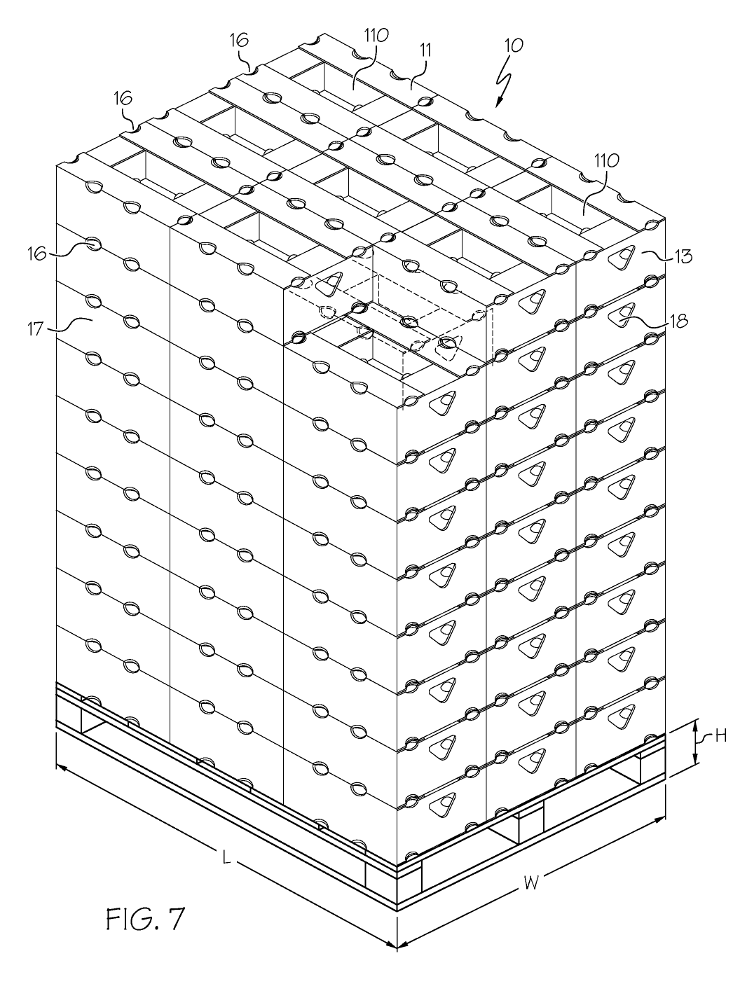

Referring to FIGS. 6-8, an improved system for packing, shipping and/or storage of produce, particularly bananas, is provided. The improved system comprises a plurality of improved containers as described above, and an ISP.

As can be seen in FIG. 6, a first layer of containers is placed on an ISP, and a second layer of nine containers is stacked on top of the first layer of containers, and so on, until eight layers of containers are stacked on the ISP (FIG. 6). In some aspects, the containers are stacked on the ISP until nine layers of nine containers each are stacked on the pallet (FIG. 7). In any case, as shown in FIG. 8, the layers of containers are configured such that at least a portion of the ventilation apertures 16a of any one container 10a is aligned with at least a portion of the ventilation apertures 16b of one or more adjacent containers 10b. By aligning the ventilation apertures in this way, at least one continuous vertical gas flow path 200, and at least one continuous horizontal gas flow path 300, extends through all of the layers of the stacked containers. In some aspects, a plurality of continuous vertical gas flow paths and/or continuous horizontal gas flow paths, extend through all of the layers of stacked containers. The gas flow paths readily allow gas to freely flow between, and among, the stacked containers and layers thereof. The resulting ventilation may facilitate varying ventilation and/or temperature control needs of the produce during transport and storage.

In addition to facilitating ventilation and/or temperature control, the improved system allows for substantially more produce to be shipped per pallet. Current pallet configurations comprise industry-standard banana boxes, which are 52 cm long, by 38 cm wide, by 25 cm high, and which are stacked on an ISP in eight layers of eight boxes each. Since industry-standard banana boxes have an MDW of about 18.1 kg, current pallet configurations have an MDW of about 870 kg per ISP. In contrast, the improved systems of the present disclosure provide for a pallet configuration, which has substantially higher MDWs. For example, by stacking the improved containers in eight layers of nine containers each, the resulting MDW may range from about 914 kg to about 936 kg per ISP, or any MDW in between. In some aspects, the resulting MDW may be about 914 kg, or about 936 kg, per ISP. By stacking the improved containers in nine layers of nine containers each, the resulting MDW may range from about 1,029 kg to about 1,053 kg per ISP, or any MDW in between. In some aspects, the resulting MDW may be about 1,029 kg, or 1,053 kg, per ISP. In sum, the improved system results in packing, storing and/or transport of from about 4.9% to about 23% more fruit on an ISP than pallet configurations. As a result of the increased efficiency of packing, storing and/or transporting fruit, particularly bananas, the improved system may drive down associated shipping and/or handling costs.

### Improved Method:

In some aspects, the disclosure is directed to a method of increasing the amount of bananas that may be shipped on an ISP. The method may comprise the following steps. A plurality of improved banana boxes, as described above is provided. Each banana box is packed with bananas. The banana boxes are stacked on a pallet in layers. In some aspects, the banana boxes are stacked in eight layers of nine boxes each (FIG. 6), and in some aspects, in nine layers of nine boxes each (FIG. 7). The boxes are positioned in the various layers such that a portion of each box's ventilation apertures is aligned with a portion of the ventilation apertures of at least one adjacent box (FIG. 8). By aligning the ventilation apertures in this way, at least one continuous vertical gas flow path 200, and at least one continuous horizontal gas flow path 300 is formed throughout the layers of boxes. In some aspects, the boxes are aligned such that a plurality of continuous vertical gas flow paths and/or continuous horizontal gas flow paths, extend through all of the layers of stacked containers. As noted above, the gas flow paths readily allow gas to freely flow between and among the stacked containers and layers thereof. The resulting ventilation may facilitate varying ventilation and/or temperature control needs of the produce during transport and storage.

All percentages and ratios given herein are “by weight” unless otherwise specified. All references cited in this specification are incorporated herein by reference, in their entirety, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All numerical ranges disclosed herein are inclusive and combinable.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular aspects of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container for packing, shipping and/or storage of produce, wherein the container is substantially rigid, and in use, the container: has outer dimensions of 40 cm long, by 35 cm wide, by 25 cm high, within a manufacturing tolerance of ±5 mm; and comprises:
a. a pair of opposed vertical side panels comprising a first vertical side panel and a second vertical side panel;
b. a pair of opposed vertical end panels comprising a first vertical end panel and a second vertical end panel;
c. a top panel;
d. a bottom panel opposed to the top panel;
e. a first set of eight ventilation apertures disposed along a top perimeter of the container; and
f. a second set of eight ventilation apertures disposed along a bottom perimeter of the container.

2. The container according to claim 1, wherein the first set of ventilation apertures is disposed substantially equidistantly along the top perimeter of the container and the second set of ventilation apertures is disposed substantially equidistantly along the bottom perimeter of the container.

3. The container according to claim 2, wherein:
a. each of the first set of ventilation apertures comprises:
1. a first portion disposed along a peripheral edge of the top panel; and
2. a second portion disposed along a peripheral edge of one of the pair of opposed vertical side panels or one of the pair of opposed vertical end panels; and
b. each of the second set of ventilation apertures comprises:
1. a first portion disposed along a peripheral edge of the bottom panel; and
2. a second portion disposed along a peripheral edge of one of the pair of opposed vertical side panels or one of the pair of opposed vertical end panels.

4. The container according to claim 2, comprising:
a. two ventilation apertures, each having a first portion disposed along a peripheral edge of the top panel and a second portion disposed along a peripheral edge of the first vertical side panel;
b. two ventilation apertures, each having a first portion disposed along a peripheral edge of the top panel and a second portion disposed along a peripheral edge of the second vertical side panel;
c. two ventilation apertures, each having a first portion disposed along a peripheral edge of the top panel and a second portion disposed along a peripheral edge of the first vertical end panel;
d. two ventilation apertures, each having a first portion disposed along a peripheral edge of the top panel and a second portion disposed along a peripheral edge of the second vertical end panel;
e. two ventilation apertures, each having a first portion disposed along a peripheral edge of the bottom panel and a second portion disposed along a peripheral edge of the first vertical side panel;
f. two ventilation apertures, each having a first portion disposed along a peripheral edge of the bottom panel and a second portion disposed along a peripheral edge of the second vertical side panel; and
g. two ventilation apertures, each having a first portion disposed along a peripheral edge of the bottom panel and a second portion disposed along a peripheral edge of the first vertical end panel;
h. two ventilation apertures, each having a first portion disposed along a peripheral edge of the bottom panel and a second portion disposed along a peripheral edge of the second vertical end panel.

5. The container according to claim 4, further comprising handholds on each of the pair of opposed vertical end panels.

6. The container according to claim 1, wherein the outer dimensions are 40 cm long, by 35 cm wide, by 25 cm high, within a manufacturing tolerance of ±3 mm.

7. The container according to claim 1, wherein the outer dimensions are 40 cm long, by 35 cm wide, by 25 cm high, within a manufacturing tolerance of ±1 mm.

8. The container according to claim 1, wherein the container has a Maximum Declared Weight of from about 12.7 kg to about 13.0 kg.

9. The container according to claim 1, wherein the container has a Maximum Declared Weight of about 12.9 kg.

10. The container according to claim 1, wherein the container is a banana box.

11. A system for packing, shipping and/or storage of produce, the system comprising:
a. a plurality of substantially rigid containers, wherein in use, each of the plurality of containers: has outer dimensions of 40 cm long, by 35 cm wide, by 25 cm high, within a manufacturing tolerance of ±5 mm; and comprises:
1. a pair of opposed vertical side panels comprising a first vertical side panel and a second vertical side panel;
2. a pair of opposed vertical end panels comprising a first vertical end panel and a second vertical end panel;
3. a top panel;
4. a bottom panel opposed to the top panel;
5. a first set of ventilation apertures comprising eight ventilation apertures disposed along a top perimeter of the container; and
6. a second set of ventilation apertures comprising eight ventilation apertures disposed along a bottom perimeter of the container; and
b. a pallet having dimensions of about 120 cm long by about 106 cm wide.

12. The system according to claim 11, wherein the first set of ventilation apertures is disposed substantially equidistantly along the top perimeter of the container and the second set of ventilation apertures is disposed substantially equidistantly along the bottom perimeter of the container.

13. The system according to claim 12, wherein:
a. each of the first set of ventilation apertures comprises:
1. a first portion disposed along a peripheral edge of the top panel; and
2. a second portion disposed along a peripheral edge of one of the pair of opposed vertical side panels or one of the pair of opposed vertical end panels; and
b. each of the second set of ventilation apertures comprises:
1. a first portion disposed along a peripheral edge of the bottom panel; and
2. a second portion disposed along a peripheral edge of one of the pair of opposed vertical side panels or one of the pair of opposed vertical end panels.

14. The system according to claim 11, each of the plurality of containers comprising:
a. two ventilation apertures, each having a first portion disposed along a peripheral edge of the top panel and a second portion disposed along a peripheral edge of the first vertical side panel;
b. two ventilation apertures, each having a first portion disposed along a peripheral edge of the top panel and a second portion disposed along a peripheral edge of the second vertical side panel;
c. two ventilation apertures, each having a first portion disposed along a peripheral edge of the top panel and a second portion disposed along a peripheral edge of the first vertical end panel;
d. two ventilation apertures, each having a first portion disposed along a peripheral edge of the top panel and a second portion disposed along a peripheral edge of the second vertical end panel;
e. two ventilation apertures, each having a first portion disposed along a peripheral edge of the bottom panel and a second portion disposed along a peripheral edge of the first vertical side panel;
f. two ventilation apertures, each having a first portion disposed along a peripheral edge of the bottom panel and a second portion disposed along a peripheral edge of the second vertical side panel; and
g. two ventilation apertures, each having a first portion disposed along a peripheral edge of the bottom panel and a second portion disposed along a peripheral edge of the first vertical end panel;
h. two ventilation apertures, each having a first portion disposed along a peripheral edge of the bottom panel and a second portion disposed along a peripheral edge of the second vertical end panel.

15. The system according to claim 11, comprising:
a. a first layer of containers supported by the pallet; and
b. a second layer of containers stacked on top of the first layer of containers;
wherein each container is positioned in the first or second layer of containers such that a portion of each container's ventilation apertures is aligned with a portion of ventilation apertures of at least one adjacent container to form through the first layer and second layer of containers:
i. at least one continuous vertical gas flow path; and
ii. at least one continuous horizontal gas flow path.

16. The system according to claim 15, comprising eight layers of containers, wherein each of the eight layers of containers comprises nine containers aligned in three adjacent rows, and further wherein: the second layer of containers is directly on top of, and aligned with, the first layer of containers, a third layer of containers is directly on top of, and aligned with, the second layer of containers, and so on, until an eighth layer of containers is directly on top of, and aligned with, a seventh layer of containers, such that throughout all of the eight layers of containers at least one continuous vertical gas flow path and at least one continuous horizontal gas flow path are formed.

17. The system according to claim 16, wherein the Maximum Declared Weight of the system is from about 914 kg to about 936 kg.

18. The system according to claim 16, wherein the Maximum Declared Weight of the system is about 936 kg.

19. The system according to claim 16, further comprising a ninth layer of containers comprising nine containers, wherein the ninth layer of containers is directly on top of, and aligned with, the eighth layer of containers, such that throughout all of the nine layers of containers at least one continuous vertical gas flow path and at least one continuous horizontal gas flow path are formed.

20. The system according to claim 19, wherein the Maximum Declared Weight of the system is from about 1,029 kg to about 1,053 kg.

21. The system according to claim 19, wherein the system has a maximum declared weight of about 1,053 kg.

22. A method of increasing the amount of bananas that may be shipped on a standard pallet having dimensions of about 120 cm long, by about 106 cm wide, the method comprising the steps of:
a. providing a plurality of banana boxes, wherein each box is substantially rigid, and in use, each box: has outer dimensions of 40 cm long, by 35 cm wide, by 25 cm high, within a manufacturing tolerance of ±5 mm; and comprises:
1. a pair of opposed vertical side panels comprising a first vertical side panel and a second vertical side panel;
2. a pair of opposed vertical end panels comprising a first vertical end panel and a second vertical end panel;
3. a top panel;
4. a bottom panel opposed to the top panel;
5. a first set of eight ventilation apertures disposed along a top perimeter of the box; and
6. a second set of eight ventilation apertures disposed along a bottom perimeter of the box;
b. packing bananas into each box; and
c. stacking the boxes on the pallet in eight layers of nine boxes each;
wherein each box is positioned in one of the eight layers such that a portion of the box's ventilation apertures is aligned with a portion of ventilation apertures of at least one adjacent box, such that throughout the layers of boxes there is at least one continuous vertical gas flow path, and at least one continuous horizontal gas flow path.

23. The method according to claim 22, further comprising the step of stacking a ninth layer of boxes on top of an eighth layer of boxes, such that throughout all the layers of boxes at least one continuous vertical gas flow path and at least one continuous horizontal gas flow path are formed.
